(19) United States
(12) Patent Application Publication
(10) Pub. No.: US 2024/0267907 A1
(43) Pub. Date: Aug. 8, 2024

(54) SYSTEMS AND METHODS OF IN-DEVICE COEXISTENCE AWARE WI-FI PREEMPTION ENHANCEMENT

(71) Applicant: Meta Platforms Technologies, LLC, Menlo Park, CA (US)

(72) Inventors: Ding Li, Fremont, CA (US); Liying Xu, Sunnyvale, CA (US); Raghuram Kamath, Sunnyvale, CA (US); Abhishek Kumar Agrawal, Bellevue, WA (US)

(73) Assignee: Meta Platforms Technologies, LLC, Menlo Park, CA (US)

(21) Appl. No.: 18/416,358

(22) Filed: Jan. 18, 2024

Related U.S. Application Data
(60) Provisional application No. 63/442,927, filed on Feb. 2, 2023.

(51) Int. Cl. H04W 72/12

(52) U.S. Cl. CPC H04W 72/1215; H04W 84/12

(57) ABSTRACT

A device may include one or more processors and a receiver configured to receive packets in a wireless local area network (WLAN). The one or more processors may be configured to dynamically allow or disallow the receiver to switch, while receiving one packet via the receiver, to receiving another packet.

### CROSS-REFERENCE TO RELATED APPLICATION

This application claims priority to U.S. Provisional Patent Application No. 63/442,927 filed on Feb. 2, 2023, which is incorporated by reference herein in its entirety for all purposes.

### FIELD OF DISCLOSURE

The present disclosure is generally related to communications, including but not limited systems and methods for a wireless device to enhance a Wi-Fi preemption using an interference pattern in an in-device coexistence environment (e.g., artificial reality environment).

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a device including one or more processors and a receiver configured to receive packets in a wireless local area network (WLAN). In some embodiments, the one or more processors may be configured to dynamically allow or disallow the receiver to switch, while receiving one packet via the receiver, to receiving another packet.

In some embodiments, the one packet may be transmitted from a transmitter in a first basic service set (BSS). The another packet may be transmitted from another transmitter in a BSS different from the first BSS.

In some embodiments, the device may include a controller configured to dynamically send a first signal or a second signal to the one or more processors. Responsive to receiving the first signal, the one or more processors may be configured to disallow the receiver to switch, while receiving via the receiver a first packet from a first transmitter, to receiving a second packet from a second transmitter. Responsive to receiving the second signal, the one or more processors may be configured to allow the receiver to switch, while receiving via the receiver a third packet from the first transmitter, to receiving a fourth packet from the second transmitter. The second packet may have a signal strength higher than a signal strength of the first packet. The fourth packet may have a signal strength higher than a signal strength of the third packet.

In some embodiments, the controller may be configured to determine that the second packet is to be transmitted at a first time from the second transmitter. Responsive to the determination, the controller may be configured to send, before the first time, the first signal to the one or more processors. At least two of the controller, the receiver, the first transmitter, or the second transmitter may communicate with one another using at least one of Universal Asynchronous Receiver-Transmitter (UART) or General-Purpose Input/Output (GPIO). The controller may be configured to determine a duration for which the second packet is to be transmitted from the second transmitter. Responsive to receiving the first signal, the one or more processors may be configured to disallow, for the duration, the receiver to switch to receiving the second packet from the second transmitter.

In some embodiments, the controller may be configured to determine a session having a start time and an end time. Responsive to determining the session, the controller may be configured to send the first signal at the start time to the one or more processors and send the second signal at the end time to the one or more processors. The controller may be configured to determine timing of traffic transmitted from the second transmitter. The controller may be configured to determine the session according to the timing of the traffic transmitted from the second transmitter. A duration of the session may be greater than or equal to one second.

Various embodiments disclosed herein are related to a method including receiving, by a receiver of a device, packets in a wireless local area network (WLAN). The method may include dynamically allowing or disallowing, by one or more processors of the device, the receiver to switch, while receiving one packet via the receiver, to receiving another packet.

In some embodiments, the one packet may be transmitted from a transmitter in a first basic service set (BSS). The another packet may be transmitted from another transmitter in a BSS different from the first BSS.

In some embodiments, a controller of the device may dynamically send a first signal or a second signal to the one or more processors. Responsive to receiving the first signal, the one or more processors of the device may disallow the receiver to switch, while receiving via the receiver a first packet from a first transmitter, to receiving a second packet from a second transmitter. Responsive to receiving the second signal, the one or more processors of the device may allow the receiver to switch, while receiving via the receiver a third packet from the first transmitter, to receiving a fourth packet from the second transmitter. The second packet may have a signal strength higher than a signal strength of the first packet. The fourth packet may have a signal strength higher than a signal strength of the third packet.

In some embodiments, the controller of the device may determine that the second packet is to be transmitted at a first time from the second transmitter. Responsive to the determination, the controller of the device may send, before the first time, the first signal to the one or more processors. At least two of the controller, the receiver, the first transmitter, or the second transmitter may communicate with one another using at least one of UART or GPIO. The controller of the device may determine a duration for which the second packet is to be transmitted from the second transmitter. Responsive to receiving the first signal, the one or more processors of the device may disallow, for the duration, the receiver to switch to receiving the second packet from the second transmitter.

In some embodiments, the controller of the device may determine a session having a start time and an end time. Responsive to determining the session, the controller of the device may send the first signal at the start time to the one or more processors and send the second signal at the end time to the one or more processors. The controller of the device may determine timing of traffic transmitted from the second transmitter. The controller of the device may determine the session according to the timing of the traffic transmitted from the second transmitter. A duration of the session may be greater than or equal to one second.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4A and FIG. 4B illustrate example scenarios in which a Wi-Fi preemption is performed, according to some implementations.

FIG. 5 illustrates an example in-device coexistence (IDC) scenario in which a Wi-Fi preemption is performed, according to some implementations.

FIG. 6 illustrate one example of dynamically allowing (e.g., enabling) or disallowing (e.g., disabling) a Wi-Fi preemption, according to an example implementation of the present disclosure.

FIG. 7 illustrate another example of dynamically allowing or disallowing a Wi-Fi preemption, according to an example implementation of the present disclosure.

FIG. 8A and FIG. 8B illustrate example scenarios in which a Wi-Fi preemption is performed, according to an example implementation of the present disclosure.

FIG. 8C is a diagram showing throughput over different loss (e.g., attenuation) values when a Wi-Fi preemption is performed, according to an example implementation of the present disclosure.

FIG. 9 is a flowchart showing a process of dynamically allowing or disallowing a Wi-Fi preemption, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

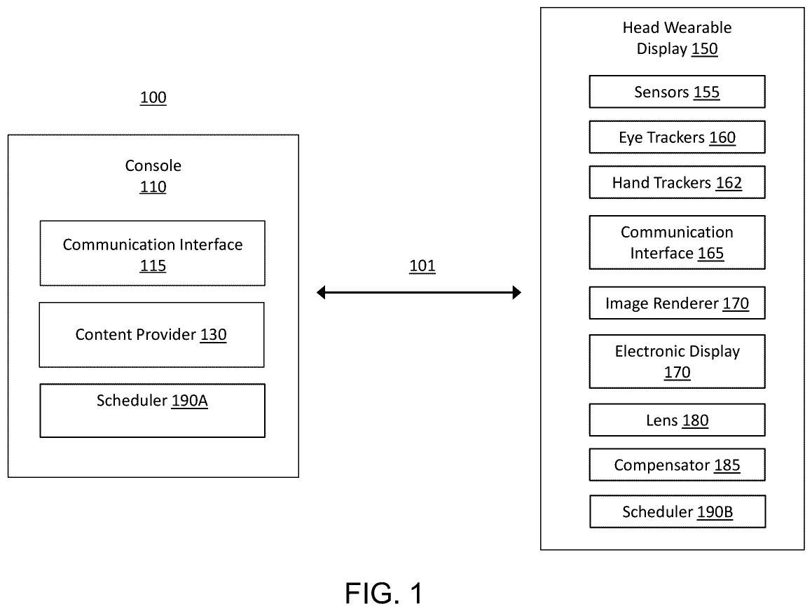

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In other implementations, the image renderer 170 generates one or more images through a shading process and a reprojection process when an image from the console 110 is not received within the frame time. For example, the shading process and the reprojection process may be performed adaptively, according to a change in view of the space of the artificial reality. In some embodiments, the electronic display 175 is an electronic component that displays an image. The electronic display 175 may for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

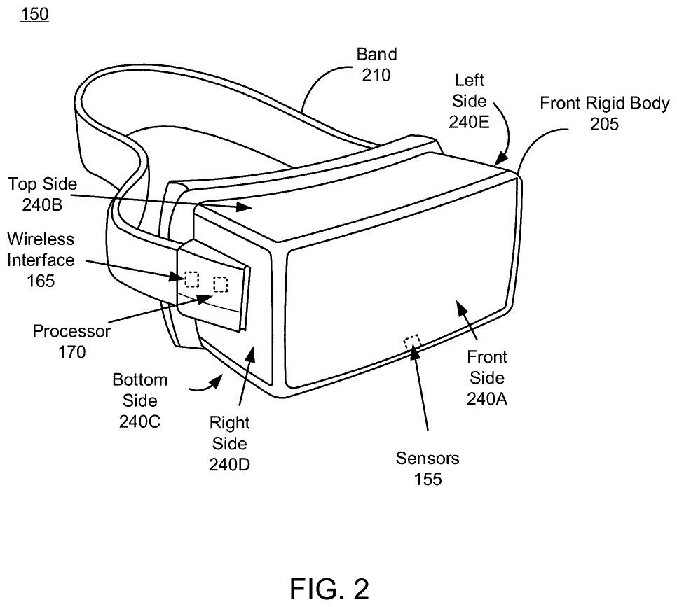

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

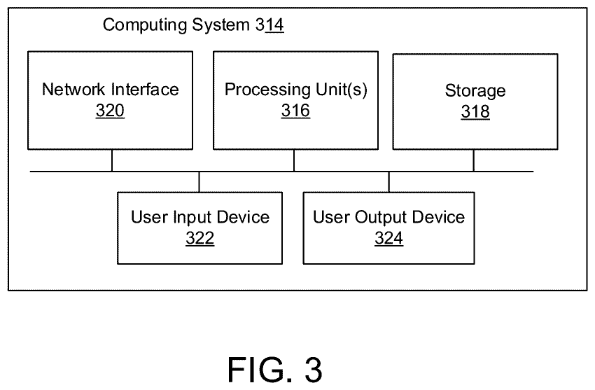

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

In one aspect, wireless technologies (e.g., Wi-Fi, Bluetooth (BT)/Bluetooth Low Energy (BLE), cellular, Ultra-wideband (UWB), etc.) may be used for VR/AR devices in multiple domains that can support premium VR/AR experience, for example, data connectivity, motion tracking and ranging based location. Challenges may arise when multiple radios are integrated into a form factor with extremely limited space. In various forms, different radios may interfere with each other and lead to poor user experience due to wireless performance degradation in terms of throughput, packet error rate, latency and/or jitter, etc. Therefore, a comprehensive and efficient design for multi-radio coexistence management becomes beneficial as a potential product differentiating point in VR/AR space.

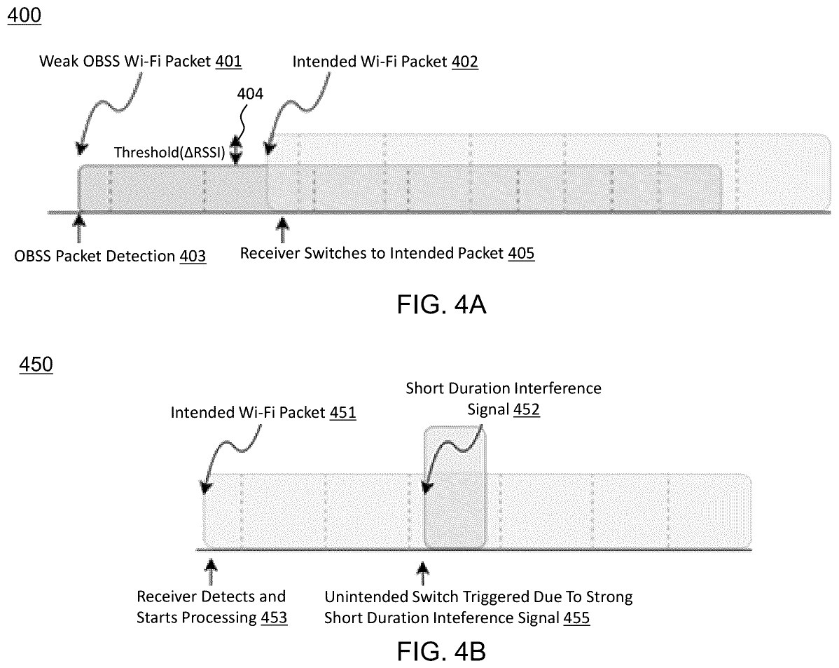

A Wi-Fi preemption feature can be designed/implemented to avoid receiver deafness due to weak, high duty cycle overlapping basic service set (OBSS) Wi-Fi traffic. The Wi-Fi Preemption feature can enable a Wi-Fi receiver to be able to switch from an unintended Wi-Fi packet (e.g., a packet directed to OBSS) to an intended Wi-Fi packet (which is directed to the Wi-Fi receiver and has a strong/high Received Signal Strength Indicator (RSSI)) in time, rather than being latched to the OBSS Wi-Fi packet (which has RSSI weaker/lower than the RSSSI of the intended Wi-Fi packet). For example, the packet switch may be performed by dropping the Wi-Fi packet with a weak signal and starting to process the Wi-Fi packet with a strong signal. The packet switch may be triggered upon automatic gain control (AGC) saturation in radio frequency front-end (RFFE) or power surge detected in Wi-Fi baseband. This type of Wi-Fi preemption/packet switch technique may also be referred to as power jump detection or packet-in-packet feature. The logic behind the switching behavior is that, in presence of strong interference, the current packet (e.g., packet with a weak signal) will not be correctly decoded even if the Wi-Fi receiver does not switch to the new packet (e.g., packet with a strong signal). The Wi-Fi preemption, however, may have an issue that in some scenarios (e.g., the scenario shown in FIG. 4B) it may significantly hurt/degrade/impair/damage Wi-Fi downlink throughput in presence of periodic interference signals with a small interval and a short packet duration. FIG. 4A and FIG. 4B illustrate example scenarios in which a Wi-Fi preemption is performed, according to some implementations. FIG. 4A shows a non-problematic scenario 400 in which a Wi-Fi preemption leads to an intended behavior with an OBSS. Referring to FIG. 4A, when a Wi-Fi receiver receives an OBSS Wi-Fi packet 401 with a weak signal (e.g., a packet directed to an OBSS), the receiver may detect 403 the OBSS packet. Then, an intended Wi-Fi packet 402 (e.g., a packet directed to the receiver) is received. The receiver may determine that a signal strength (e.g., RSSI or a signal-to-noise ratio (SNR)) of the intended packet 402 is greater than a signal strength of the OBSS packet by at least a threshold (e.g., an RSSI Delta (Δ) Threshold 404), and switch from the OBSS Wi-Fi packet 401 to the intended packet 402. Even if the packet with a strong (e.g., stronger relative to signal strength of the weak signal) signal is not directed to the receiver, switching to the packet with the strong signal may not hurt/impair/degrade the performance, because the packet with the weak (e.g., weaker relative to signal strength of the strong signal) signal may not be correctly decoded even if the receiver does not switch to the packet with the strong signal.

FIG. 4B shows a problematic scenario 450 in which a Wi-Fi preemption leads to an unintended behavior due to a short duration interference signal. Referring to FIG. 4B, when a Wi-Fi receiver receives an intended Wi-Fi packet 451 with a weak signal (e.g., packet directed to the receiver), the receiver may detect and start processing 453 the intended packet 451. Then, a short duration interference signal/packet 452 (e.g., signal from another radio in the same device) is received. The receiver may determine that a signal strength (e.g., RSSI or SNR) of the signal 452 is greater than a signal strength of the intended packet 451 by at least a threshold (e.g., an RSSI Delta (Δ) Threshold), and may switch to the interference signal/packet 452. That is, unintended switch may be triggered due to a strong short duration interference signal.

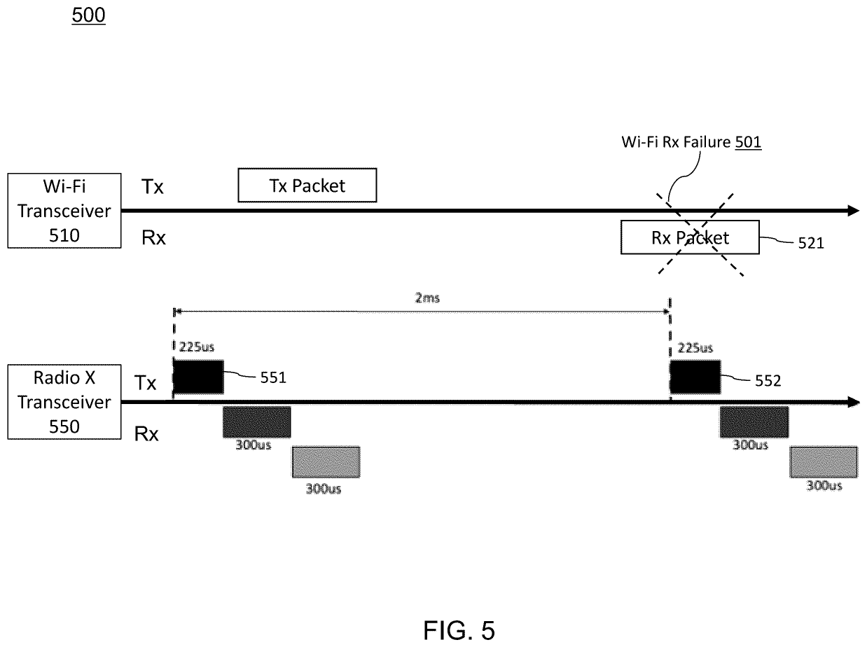

FIG. 5 illustrates an example in-device coexistence (IDC) scenario in which a Wi-Fi preemption is performed, according to some implementations. FIG. 5 shows another problematic scenario 500 in which a Wi-Fi preemption leads to an unintended behavior due to a packet with a strong signal transmitted from another radio transceiver. FIG. 5 shows one example of coexistence between a Wi-Fi transceiver 510 and another transceiver 550 (referred to as “Radio X transceiver”) operating on the same 2.4 GHz industrial, scientific, and medical (ISM) band. Referring to FIG. 5, while the Wi-Fi transceiver 510 detects/processes a Wi-Fi packet 521 with a weak signal, the transceiver 30 mayfail to successfully receive the packet 521 with the weak signal due to unintended triggering of Wi-Fi preemption (e.g., unintended switching to a packet 552 with a strong signal) in presence of interference by the packet 552 with the strong signal transmitted from the radio X transceiver 550 which may co-exist with the Wi-Fi transceiver 510 on the same device. The radio X transceiver 550 may transmit packets 551, 552 periodically (e.g., for a transmission duration of 225 μs with an interval of 2 ms).

To address this problem, a system/method may enhance a Wi-Fi preemption by leveraging the knowledge of traffic of another radio or transceiver. One of the reasons why other preemption design cannot handle the scenarios described above (e.g., those shown in FIG. 4A, FIG. 4B and FIG. 5) is that a Wi-Fi receiver generally has little information about the interference signal, making it very difficult to do any adaptation from the default triggering logic (supported in the traditional preemption design). For example, in an in-device coexistence scenario (e.g., coexistence between the Wi-Fi transceiver 510 and the radio X transceiver 550 both operating on the same band as shown in FIG. 5), a Wi-Fi receiver (or transceiver) of a device (e.g., VR/AR device) can know/detect/be aware of a traffic state (active/inactive) of another radio (e.g., interference signal pattern) to some extent. The Wi-Fi receiver may well understand the interference signal state (active/inactive) of Radio X in advance, which enables enhancement over traditional Wi-Fi preemption to avoid unintended switch triggering.

In one approach, a Wi-Fi receiver (or transceiver) of a device (e.g., VR/AR device) can know/detect/be aware of a detailed traffic state of another radio (e.g., interference signal pattern or Tx timing) by using a real-time interface such as general-purpose input/output (GPIO), universal Asynchronous Receiver/Transmitter (UART). In some embodiments, the interference signal may be transmitted in an in-device coexistence scenario, e.g., transmitted from one or more radios on the same device.

In some embodiments, a controller of a device can know/detect/be aware of Tx timing of another radio and perform a dynamic control of Wi-Fi preemption based on the Tx timing of another radio. In some embodiments, the controller may be implemented using at least one of software, firmware, hardware, or a combination thereof. In some embodiments, the controller may dynamically control a Wi-Fi preemption using hardware. In some embodiments, the controller can know/detect/be aware of Tx timing of another radio using a real-time interface such as general-purpose input/output (GPIO), universal Asynchronous Receiver/Transmitter (UART). Based on the detected Tx timing of another radio, the controller can generate either a first signal disabling (or disallowing) the Wi-Fi preemption, or a second signal enabling (or allowing) the Wi-Fi preemption. In some embodiments, responsive to receiving the first signal, one or more processors of the device may dynamically disable or disallow switching upon indication of transmission by another radio (e.g., radio X Tx packet). In some embodiments, responsive to receiving the second signal, the one or more processors of the device may dynamically enable or allow switching to a packet transmitted by another radio.

In some embodiments, the controller (or one or more processors, Wi-Fi transceiver) may detect/be aware of/know the traffic state of the radio X (e.g., transmission (Tx) timing of a packet transmitted by the radio X transceiver) in real time using GPIO and/or UART. The transmission timing of a packet may include a Tx start time, a Tx end time, and/or a Tx duration of the packet. Upon detecting the Tx timing, the controller may generate a first (disable) signal before the Tx start time so that the one or more processors or the Wi-Fi transceiver can disable/disallow the Wi-Fi preemption at the Tx start time. In some embodiments, responsive to receiving the first (disable) signal, the one or more processors may disable/disallow the Wi-Fi transceiver to perform the Wi-Fi preemption at the Tx start time. The Wi-Fi preemption can be disabled/disallowed during the Tx duration of the packet. The controller may generate a second (enable) signal before the Tx end time so that one or more processors or the Wi-Fi transceiver can enable/allow the Wi-Fi preemption at the Tx end time. In some embodiments, responsive to receiving the second (enable) signal, the one or more processors may enable/allow the Wi-Fi transceiver to perform the Wi-Fi preemption at the Tx end time. In this manner, using the traffic state of the radio X, the Wi-Fi transceiver can perform real-time dynamic control of Wi-Fi preemption, e.g., disable Wi-Fi preemption during the transmission of packets (e.g., Tx duration of each packet). In some embodiments, the dynamic control of Wi-Fi preemption can be implemented in hardware and can be performed in a microsecond level.

In one approach, a Wi-Fi receiver (or transceiver) of a first device (e.g., VR/AR device) can know/detect/be aware of a traffic state (active/inactive) of another radio by communicating indication of traffic session (e.g., a duration in which transmission from another radio is active) through host software in a semi-static manner. In some embodiments, the interference signal may be transmitted in an in-device coexistence scenario, e.g., transmitted from one or more radios on the same device (e.g., the first device). In some embodiments, the interference signal may be transmitted from one or more radios on another device (e.g., a device different from the first device).

In some embodiments, a controller of a device can know/detect/be aware of a traffic state (active/inactive) of another radio and perform a dynamic control of Wi-Fi preemption based on the traffic state of another radio. In some embodiments, the controller may be implemented using at least one of software or firmware (e.g., host software/firmware), or a combination thereof. In some embodiments, the controller may control to enable/disable the Wi-Fi preemption using a software/firmware-level interface. In some embodiments, the controller may define a (traffic) session as granularity of preemption control. For example, a session can be defined as a duration in which a traffic state of another radio (e.g., radio X) is active. In some embodiments, a duration of the session may be greater than or equal to 1 second (e.g., 10 seconds, 1 minute, 10 minutes, etc.). For example, a 10 second session may include a number of periodical transmissions of packets from radio X. In some embodiments, if real-time interface hardware support (e.g., UART and/or GPIO) is not available, the controller may perform a session-based preemption control by communicating indication of a traffic session through host software in a semi-static manner (e.g., a combination of static Wi-Fi preemption control at fixed times/duration or dynamic Wi-Fi preemption control depending on traffic variation), so that the Wi-Fi preemption is disabled whenever transmission from Radio X is active.

In some embodiments, the controller may include one or more host software that can interact with each radio (e.g., Wi-Fi, BT, BLE, cellular, UWB, etc.) to define a traffic session. For example, BT host software may send session information (e.g., session indication) to Wi-Fi host software (via inter-process communication (IPC) or computer network, for example), then the Wi-Fi host software may passe/send/transmit the session information down to a Wi-Fi receiver (or transceiver) or one or more processors. There may be two types of indications—(1) indication of session start and (2) indication of session end. Some delay may occur during communication of indications. For example, a Wi-Fi transceiver may be aware of a session start of Radio X transmission 100 ms later than the time the transmission has actually started, so that negative impact of Wi-Fi preemption may occur during the 100 ms delay. The Wi-Fi transceiver may be aware of a session end of Radio transmission 200 ms later than the time the transmission has ended, so that negative impact of no preemption may incur during 200 ms. In some embodiments, upon receiving an indication of session start, the controller may

generate a first (disable) signal so that the one or more processors or the Wi-Fi transceiver can disable/disallow the Wi-Fi preemption. In some embodiments, responsive to receiving the first (disable) signal, the one or more processors may disable/disallow the Wi-Fi transceiver to perform the Wi-Fi preemption. The Wi-Fi preemption can be disabled/disallowed during a duration of the session (e.g., 10 seconds). In some embodiments, upon receiving an indication of session end, the controller may generate a second (enable) signal so that the one or more processors or the Wi-Fi transceiver can enable/allow the Wi-Fi preemption. In some embodiments, responsive to receiving the second (enable) signal, the one or more processors may enable/allow the Wi-Fi transceiver to perform the Wi-Fi preemption.

Embodiments in the present disclosure have at least the following advantages and benefits. First, embodiments in the present disclosure can provide useful techniques for a Wi-Fi receiver (or transceiver) of a device (e.g., VR/AR device) to know/detect/be aware of a traffic state (active/inactive) of another radio (e.g., interference signal pattern). Using these techniques, the Wi-Fi receiver may well understand the interference signal state (active/inactive) of Radio X in advance, which enables enhancement over certain implementations of Wi-Fi preemption to avoid unintended switch triggering.

Second, embodiments in the present disclosure can provide useful techniques for providing both a hardware (or a combination of hardware/firmware) technique or a software (or a combination of software/firmware) technique to know/detect/be aware of a traffic state (active/inactive) of another radio. For example, using a real-time (hardware) interface such as GPIO and/or UART, a Wi-Fi receiver (or transceiver) of a device (e.g., VR/AR device) can know/detect/be aware of a detailed traffic state of another radio (e.g., interference signal pattern or Tx timing). Alternatively, using software (e.g., host software), a controller of a device can know/detect/be aware of a traffic state (active/inactive) of another radio and perform a dynamic control of Wi-Fi preemption based on the traffic state of another radio.

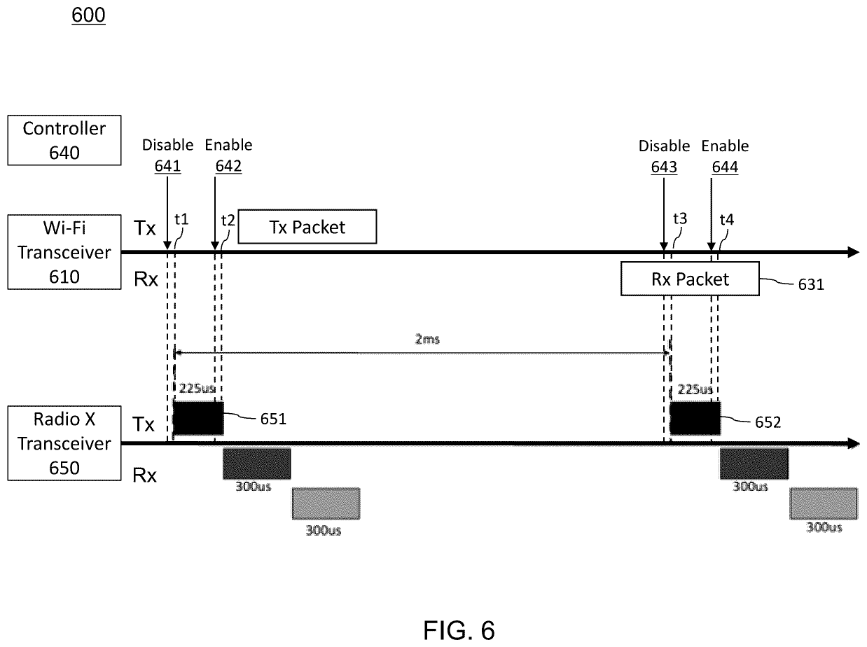

FIG. 6 illustrate one example 600 of dynamically allowing (e.g., enabling) or disallowing (e.g., disabling) a Wi-Fi preemption, according to an example implementation of the present disclosure. Referring to FIG. 6, a Wi-Fi receiver (e.g., Wi-Fi transceiver 610) and/or a controller 640 of a device (e.g., VR/AR device) can know/detect/be aware of a detailed traffic state of another radio (e.g., radio X transceiver 650) by using a real-time interface such as general-purpose input/output (GPIO), universal Asynchronous Receiver/Transmitter (UART). For example, at least two of a controller 640, the Wi-Fi transceiver 610, or the radio X transceiver 650 communicate with one another using the interface such as GPIO and/or UART. The detailed traffic state may include at least one of an interference signal pattern or Tx timing. In some embodiments, an interference signal may be transmitted in an in-device coexistence scenario, e.g., transmitted from one or more radios on the same device. For example, in FIG. 6, the controller 640, the Wi-Fi transceiver 610, and the radio X transceiver 650 may co-exist on the same device.

Referring to FIG. 6, the controller 640 can know/detect/be aware of Tx timing of another radio and perform a dynamic control of Wi-Fi preemption based on the Tx timing of the radio X transceiver 650. The controller 640 may be implemented using at least one of software, firmware, hardware, or a combination thereof. In some embodiments, the controller 640 may dynamically control a Wi-Fi preemption using hardware. Based on the detected Tx timing of the radio X transceiver 650, the controller 640 can generate either a first signal disabling (or disallowing) the Wi-Fi preemption (e.g., disable signals 641, 643), or a second signal enabling (or allowing) the Wi-Fi preemption (e.g., enable signals 642, 644). Responsive to receiving the first signal (e.g., disable signal 641), one or more processors of the device (e.g., processors 316 or Wi-Fi transceiver 610) may dynamically disable or disallow switching upon indication of transmission by another radio (e.g., radio X Tx packet 651). Similarly, responsive to receiving the disable signal 643, the one or more processors of the device may dynamically disable or disallow switching upon indication of transmission of the radio X Tx packet 652. Responsive to receiving the second signal (e.g., enable signal 642, 644), the one or more processors of the device may dynamically enable or allow switching to a packet transmitted by another radio.

In some embodiments, at least one of the controller 640, the one or more processors, or the Wi-Fi transceiver 610 may detect/be aware of/know the traffic state of the radio X (e.g., Tx timing of a packet transmitted by the radio X transceiver 650) in real time using GPIO and/or UART. The transmission timing of a packet may include a Tx start time, a Tx end time, and/or a Tx duration of the packet (e.g., 225 μs for the Tx packet 651). Upon detecting the Tx timing, the controller 640 may generate a first (disable) signal (e.g., disable signal 641, 643) before the Tx start time (e.g., Tx start time t1, t3 of the Tx packet 651, 652) so that the one or more processors or the Wi-Fi transceiver 650 can disable/disallow the Wi-Fi preemption at the Tx start time. Responsive to receiving the first (disable) signal (e.g., disable signal 641, 643) from the controller 640, the one or more processors may disable/disallow the Wi-Fi transceiver 610 to perform the Wi-Fi preemption at the Tx start time (e.g., Tx start time t1, t3 of the Tx packet 651, 652). The Wi-Fi preemption can be disabled/disallowed during the Tx duration of the packet (e.g., during 225 μs for the Tx packet 651, 652). For example, in FIG. 6, the Wi-Fi preemption can be disabled during the Tx duration between t3 and t4 so that the Wi-Fi transceiver can continue to receive/process the Rx packet 631 without switching to receiving the packet 652. The controller may generate a second (enable) signal (e.g., enable signal 642, 644) before the Tx end time (e.g., Tx end time t2, t4 of the Tx packet 651, 652) so that one or more processors or the Wi-Fi transceiver can enable/allow the Wi-Fi preemption at the Tx end time. Responsive to receiving the second (enable) signal (e.g., enable signal 642, 644) from the controller 640, the one or more processors may enable/allow the Wi-Fi transceiver 610 to perform the Wi-Fi preemption at the Tx end time (e.g., Tx end time t2, t4 of the Tx packet 651, 652). In this manner, using the detailed traffic state of the radio X transceiver 650, the Wi-Fi transceiver 610 can perform real-time dynamic control of Wi-Fi preemption, e.g., disable Wi-Fi preemption during the transmission of packets (e.g., Tx duration of each packet 651, 652). In some embodiments, the dynamic control of Wi-Fi preemption can be implemented in hardware and can be performed in a microsecond level.

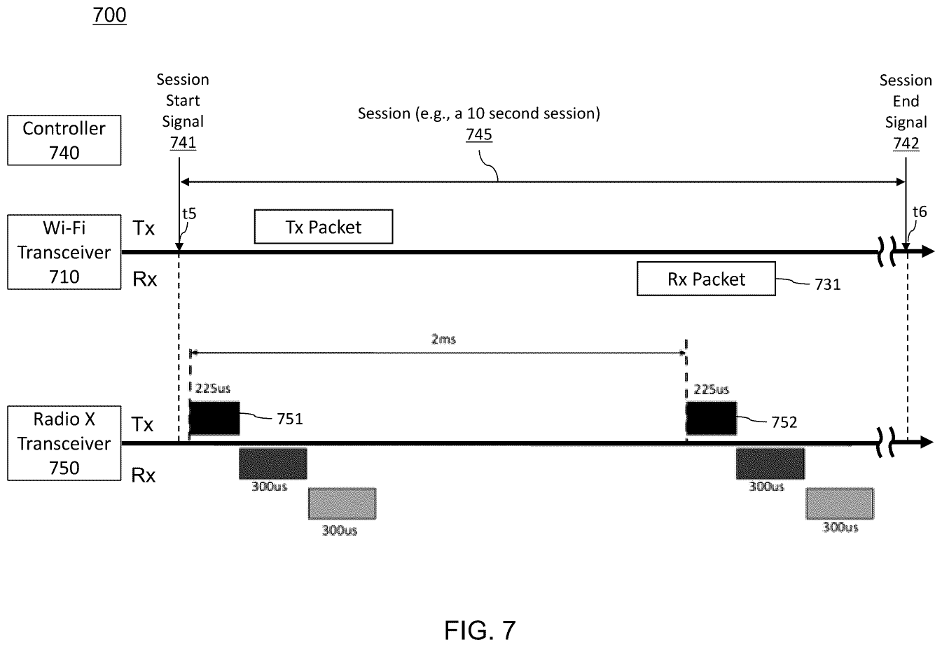

FIG. 7 illustrate another example 700 of dynamically allowing or disallowing a Wi-Fi preemption, according to an example implementation of the present disclosure. Referring to FIG. 7, a Wi-Fi receiver (e.g., Wi-Fi transceiver 710) and/or a controller 740 of a first device (e.g., VR/AR device) can know/detect/be aware of a traffic state (active/inactive) of another radio (e.g., radio X transceiver 750) by communicating indication of traffic session (e.g., a duration in which transmission from another radio is active) through host software in a semi-static manner. In some embodiments, the interference signal (e.g., Tx packets 751, 752 from the radio X transceiver 750) may be transmitted in an in-device coexistence scenario, e.g., transmitted from one or more radios on the same device (e.g., the first device). For example, in FIG. 7, the controller 740, the Wi-Fi transceiver 710, and the radio X transceiver 750 may co-exist on the same device. In some embodiments, the interference signal (e.g., Tx packets 751, 752 from the radio X transceiver 750) may be transmitted from one or more radios on another device (e.g., a device different from the first device). For example, in FIG. 7, the controller 740 and the Wi-Fi transceiver 710 may be included in the first device, while the radio X transceiver 750 may be included in a device different from the first device.

Referring to FIG. 7, the controller 740 can know/detect/be aware of a traffic state (active/inactive) of the radio X transceiver 750 and perform a dynamic control of Wi-Fi preemption based on the detected traffic state of the radio X transceiver 750. The controller 740 may be implemented using at least one of software or firmware (e.g., host software/firmware), or a combination thereof. The controller 740 may control to enable/disable the Wi-Fi preemption using a software/firmware-level interface. The controller 740 may define/obtain/calculate/compute a (traffic) session as granularity of preemption control. For example, a session 745 can be defined as a duration in which a traffic state of another radio (e.g., the radio X transceiver 750) is active. As shown in FIG. 7, a session 745 can be defined as a duration between time t5 and time t6 in which the radio X transceiver 750 periodically transmits packets (e.g., packets 751, 752) with an interval of 2 ms. In some embodiments, a duration of the session may be greater than or equal to 1 second (e.g., 10 seconds, 1 minute, 10 minutes, etc.). For example, in FIG. 7, the 10 second session 745 may include a number of periodical transmissions of packets from the radio X transceiver 750 (e.g., approximately 500 transmissions of packets from the radio X transceiver 750 during the session 745). In some embodiments, if real-time interface hardware support (e.g., UART and/or GPIO) is not available, the controller 700 may perform a session-based preemption control by communicating indication of a traffic session through host software in a semi-static manner (e.g., a combination of static Wi-Fi preemption control at fixed times/duration or dynamic Wi-Fi preemption control depending on traffic variation), so that the Wi-Fi preemption is disabled whenever transmission from Radio X is active.

In some embodiments, the controller may include one or more host software that can interact with each radio (e.g., Wi-Fi, BT, BLE, cellular, UWB, etc.) to define a traffic session. For example, if the radio X transceiver 750 is a BT transceiver, BT host software may send session information (e.g., session indication) of the radio X transceiver 750 to Wi-Fi host software (via inter-process communication (IPC) or computer network, for example), then the Wi-Fi host software may passe/send/transmit the session information down to the Wi-Fi transceiver 750 or one or more processors (e.g., processors 316) of the first device. There may be two types of indications—(1) indication of session start and (2) indication of session end. Some delay may occur during communication of indications. For example, the Wi-Fi transceiver may be aware of a session start of Radio X transmission 100 ms later than the time the transmission has actually started, so that negative impact of Wi-Fi preemption may occur during the 100 ms delay. The Wi-Fi transceiver may be aware of a session end of Radio transmission 200 ms later than the time the transmission has ended, so that negative impact of no preemption may incur during 200 ms.

Referring to FIG. 7, upon receiving an indication of session start (from BT host software, for example), the controller 740 may generate a first (disable) signal (e.g., session start signal 741) so that the one or more processors or the Wi-Fi transceiver 710 can disable/disallow the Wi-Fi preemption. Responsive to receiving the first (disable) signal (e.g., session start signal 741) from the controller 740, the one or more processors may disable/disallow the Wi-Fi transceiver 710 to perform the Wi-Fi preemption. The Wi-Fi preemption can be disabled/disallowed during a duration of the session 745 (e.g., 10 seconds). For example, in FIG. 7, the Wi-Fi preemption can be disabled during the whole 10 second session 745 so that the Wi-Fi transceiver 710 can receive/process the Rx packet 731 without switching to receiving the packet 752. Upon receiving an indication of session end (from the BT host software, for example), the controller 740 may generate a second (enable) signal (e.g., session end signal 742) so that the one or more processors or the Wi-Fi transceiver 710 can enable/allow the Wi-Fi preemption. Responsive to receiving the second (enable) signal (e.g., session end signal 742), the one or more processors may enable/allow the Wi-Fi transceiver 710 to perform the Wi-Fi preemption.

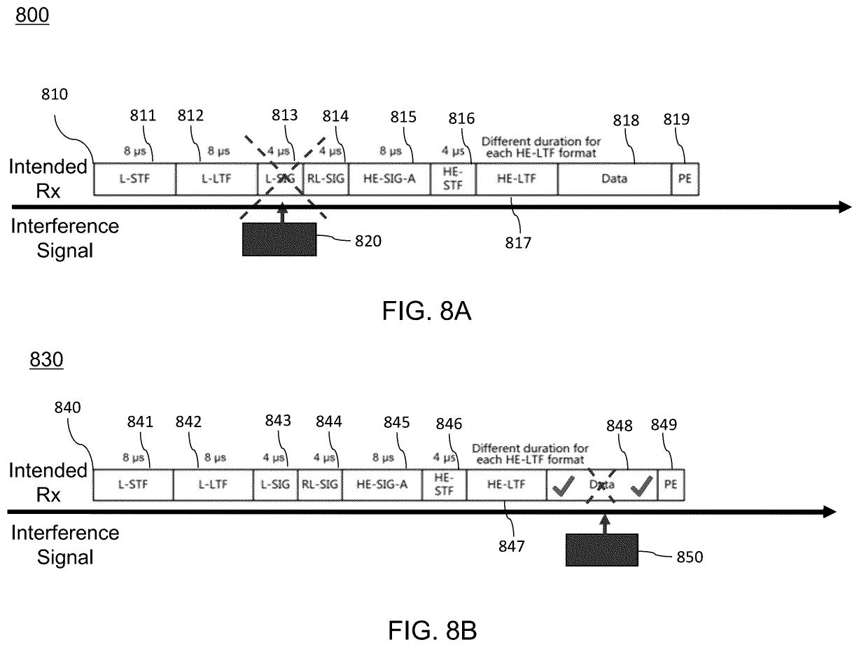

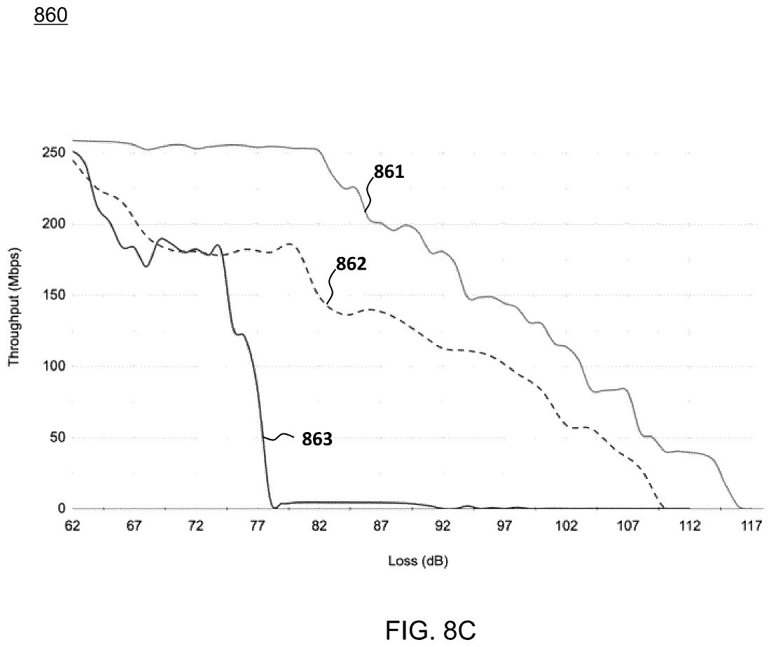

FIG. 8A and FIG. 8B illustrate example scenarios 800, 830 in which a Wi-Fi preemption is performed, according to an example implementation of the present disclosure. Although the Wi-Fi packet decoding might still fail due to a strong interference signal irrespective of the duration of the interference signal, the overall Wi-Fi downlink throughput can be improved by Wi-Fi preemption schemes according to some embodiments (e.g., embodiments shown in FIG. 6 and FIG. 7). An analysis result of the performance of the Wi-Fi preemption schemes according to some embodiments in the example scenarios 800, 830 will be described in the following sections.

Referring to FIG. 8A, in the example scenario 800, a preamble of a downlink (DL) single user (SU) physical layer protocol data unit (PPDU) 810 may include fields of L-STF (non-high throughput (HT) short training field) 811 (8 μs), L-LTF (non-HT long training field) 812 (8 μs), L-SIG (non-HT signal) 813 (4 μs), RL-SIG (repeated non-HT signal) 814 (4 μs), HE-SIG-A (high efficiency (HE) signal A) 815 (8 μs), HE-STF (HE short training field) 816 (4 82 s), and/or HE-LTF (HE long training field) 817 (which may have different duration for each high efficiency (HE)-LTF format). The PPDU 810 may also include fields of data 818, and/or PE (packet extension) 819. When a Wi-Fi preemption scheme according to some embodiments is performed, if an interference signal/packet 820 (e.g., from a radio X transceiver) hits the preamble of the DL PPDU 810 (e.g., the L-SIG field 813), the Wi-Fi transceiver may attempt to decode the PPDU 810 (instead of switching to receiving the packet 820); however, decoding of the entire SU PPDU 810 may fail. In other words, the HE SU PPDU 810 may be dismissed due to the PPDU preamble being corrupted. However, this result is the same as that when the traditional Wi-Fi preemption is applied (e.g., switching away from the current PPDU decoding to the packet 820). Therefore, in the example scenario 800, the Wi-Fi preemption scheme according to some embodiments shows at least the same performance as the traditional Wi-Fi preemption.

Referring to FIG. 8B, in the example scenario 830, a preamble of a DL SU PPDU 840 may include fields of L-STF 841 (8 μs), L-LTF 842 (8 μs), L-SIG 843 (4 82 s), RL-SIG 844 (4 μs), HE-SIG-A 845 (8 μs), HE-STF 846 (4 μs), and/or HE-LTF 847 (which may have different duration for each HE-LTF format). The PPDU 840 may also include fields of data 848, and/or PE 849. When a Wi-Fi preemption scheme according to some embodiments is performed, if an interference signal/packet 850 (e.g., from a radio X transceiver) hits the payload of the DL PPDU 840 (e.g., the data field 848), the Wi-Fi transceiver may attempt to decode/process the PPDU 840 (instead of switching to receiving the packet 820). In this case, only part of the aggregate MAC protocol data unit (A-MPDU) may be impacted and/or corrupted. The impacted MPDU can be retransmitted based on Block Ack bitmap. For example, the PPDU 840 can be finally conveyed/delivered with partial payload (MPDUs) retransmitted in the next PPDU. On the other hand, when the traditional Wi-Fi preemption is used, the entire frame (e.g., the entire A-MPDU) may be retransmitted. Therefore, in the example scenario 830, the Wi-Fi preemption scheme according to some embodiments can show better performance over the traditional Wi-Fi preemption.

FIG. 8C is a diagram 860 showing throughput (Mbps) in y axis over different loss values (e.g., different attenuation values) in x axis, when a Wi-Fi preemption is performed, according to an example implementation of the present disclosure. The y axis shows a throughput (e.g., downlink (DL) data rate vs. range (RvR)). The x axis shows different attenuation values between a transmitter and a receiver (e.g., by intentionally decreasing the signal strength or changing the distance between the transmitter and the receiver). FIG. 8C shows a result of performance comparison between the traditional Wi-Fi preemption (line 863) and the Wi-Fi preemption according to some embodiments (line 862). Line 861 indicates a baseline throughput with the Wi-Fi receiver alone (in other words, no radio X, no interference). Referring to FIG. 8C, the Wi-Fi preemption scheme according to some embodiments (indicated by line 862) shows greater throughput than that of the traditional preemption (indicated by line 62) over different loss (attenuation) values. Significant performance improvements can be achieved using the Wi-Fi preemption scheme according to some embodiments.

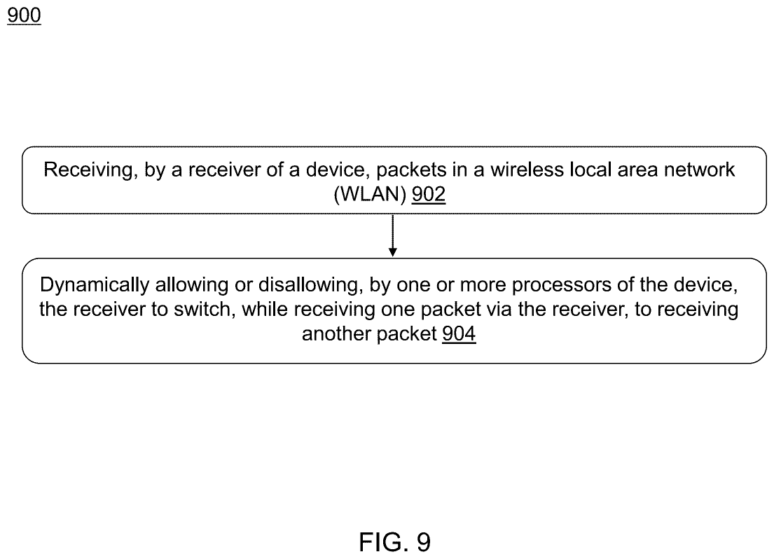

FIG. 9 is a flowchart showing a process 900 of dynamically allowing or disallowing a Wi-Fi preemption, according to an example implementation of the present disclosure. In some embodiments, the process 900 is performed by a device (e.g., console 110, HWD 150) which includes one or more processors (e.g., processors 315) a controller (e.g., controller 640, 740) and a receiver (e.g., transceiver 610, 710). In some embodiments, in an in-device coexistence (IDC) environment, another transceiver (e.g., radio X transceiver 650, 750) may co-exist with the controller and the receiver on the same device. In some embodiments, another transceiver (e.g., radio X transceiver 650, 750) may be included in a different device. In some embodiments, the process 900 is performed by other entities. In some embodiments, the process 900 includes more, fewer, or different steps than shown in FIG. 9.

In one approach, the device may receive 902, by the receiver (e.g., transceiver 610, 710), packets in a WLAN. In one approach, the device (e.g., controller 640, 740) may dynamically allow or disallow 904, by the one or more processors, the receiver to switch, while receiving one packet (e.g., Rx packets 631, 731) via the receiver, to receiving another packet (e.g., Rx packets 652, 752). In some embodiments, the one packet may be transmitted from a transmitter in a first basic service set (BSS). The another packet may be transmitted from another transmitter in a BSS different from the first BSS. For example, the Rx packets 652, 752 may be transmitted from a BSS (e.g., OBSS) different from a BSS (e.g., the BSS to which the device belongs) in which the Rx packets 631, 731 are transmitted.

In some embodiments, the controller of the device (e.g., controller 640, 740) may dynamically send a first signal (e.g., disable signals 641, 643, session start signal 741) or a second signal (e.g., enable signals 642, 644, session end signal 742) to the one or more processors. Responsive to receiving the first signal, the one or more processors of the device may disallow the receiver to switch, while receiving via the receiver a first packet from a first transmitter, to receiving a second packet from a second transmitter (e.g., disabling/disallowing the Wi-Fi preemption). Responsive to receiving the second signal, the one or more processors of the device may allow the receiver to switch, while receiving via the receiver a third packet from the first transmitter, to receiving a fourth packet from the second transmitter (e.g., enabling/allowing the Wi-Fi preemption). The second packet may have a signal strength (e.g., RSSI or SNR) higher than a signal strength of the first packet. The fourth packet may have a signal strength (e.g., RSSI or SNR) higher than a signal strength of the third packet.

In some embodiments, the controller of the device (e.g., controller 640) may determine that the second packet (e.g., Rx packet 652) is to be transmitted at a first time (e.g., time t3) from the second transmitter (e.g., radio X transceiver 650). Responsive to the determination, the controller of the device may send, before the first time (e.g., before time t3), the first signal (e.g., disable signal 643) to the one or more processors. At least two of the controller, the receiver, the first transmitter, or the second transmitter may communicate with one another using at least one of Universal Asynchronous Receiver-Transmitter (UART) or General-Purpose Input/Output (GPIO). The controller 640 may determine a duration (e.g., 225 82 s) for which the second packet (e.g., Rx packet 652) is to be transmitted from the second transmitter (e.g., radio X transceiver 650). Responsive to receiving the first signal (e.g., disable signal 643), the one or more processors of the device may disallow, for the duration, the receiver to switch/transition/change to receiving the second packet from the second transmitter (e.g., disabling/disallowing switch to receiving the Rx packet 652).

In some embodiments, the controller of the device (e.g., controller 740) may determine a session (e.g., session 745) having a start time (e.g., time t5) and an end time (e.g., time t6). Responsive to determining the session, the controller 740 may send the first signal (e.g., session start signal 741) at the start time (e.g., time 5) to the one or more processors and send the second signal (e.g., session end signal 742) at the end time (e.g., time t6) to the one or more processors. The controller of the device (e.g., host software such as Wi-Fi host software or BT host software) may determine timing of traffic transmitted from the second transmitter (e.g., radio X transceiver 750). The controller of the device may determine the session (e.g., session 745) according to the timing of the traffic transmitted from the second transmitter (e.g., periodic transmission of packets 751, 752 with an interval of 2 ms). A duration of the session (e.g., 10 second duration of the session 745) may be greater than or equal to one second.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements. Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure. References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
a receiver configured to receive packets in a wireless local area network (WLAN); and
one or more processors configured to:
dynamically allow or disallow the receiver to switch, while receiving one packet via the receiver, to receiving another packet.

2. The device according to claim 1, wherein
the one packet is transmitted from a transmitter in a first basic service set (BSS), and
the another packet is transmitted from another transmitter in a BSS different from the first BSS.

3. The device according to claim 1, further comprising:
a controller configured to dynamically send a first signal or a second signal to the one or more processors,
wherein the one or more processors are configured to:
responsive to receiving the first signal, disallow the receiver to switch, while receiving via the receiver a first packet from a first transmitter, to receiving a second packet from a second transmitter; and
responsive to receiving the second signal, allow the receiver to switch, while receiving via the receiver a third packet from the first transmitter, to receiving a fourth packet from the second transmitter.

4. The device according to claim 3, wherein
the second packet has a signal strength higher than a signal strength of the first packet, and
the fourth packet has a signal strength higher than a signal strength of the third packet.

5. The device according to claim 3, wherein
the controller is configured to:
determine that the second packet is to be transmitted at a first time from the second transmitter; and
responsive to the determination, send, before the first time, the first signal to the one or more processors.

6. The device according to claim 5, wherein
at least two of the controller, the receiver, the first transmitter, or the second transmitter communicate with one another using at least one of Universal Asynchronous Receiver-Transmitter (UART) or General-Purpose Input/Output (GPIO).

7. The device according to claim 6, wherein
the controller is configured to determine a duration for which the second packet is to be transmitted from the second transmitter; and
responsive to receiving the first signal, the one or more processors may be configured to disallow, for the duration, the receiver to switch to receiving the second packet from the second transmitter.

8. The device according to claim 3, wherein
the controller is configured to:
determine a session having a start time and an end time; and
responsive to determining the session, send the first signal at the start time to the one or more processors and send the second signal at the end time to the one or more processors.

9. The device according to claim 8, wherein
the controller is configured to:
determine timing of traffic transmitted from the second transmitter; and
determine the session according to the timing of the traffic transmitted from the second transmitter.

10. The device according to claim 8, wherein a duration of the session is greater than or equal to one second.

11. A method comprising:
receiving, by a receiver of a device, packets in a wireless local area network (WLAN); and
dynamically allowing or disallowing, by one or more processors of the device, the receiver to switch, while receiving one packet via the receiver, to receiving another packet.

12. The method according to claim 11, wherein
the one packet is transmitted from a transmitter in a first basic service set (BSS), and
the another packet is transmitted from another transmitter in a BSS different from the first BSS.

13. The method according to claim 11, further comprising:
dynamically sending, by a controller of the device, a first signal or a second signal to the one or more processors;
responsive to receiving the first signal, disallowing, by the one or more processors of the device, the receiver to switch, while receiving via the receiver a first packet from a first transmitter, to receiving a second packet from a second transmitter; and
responsive to receiving the second signal, allowing, by the one or more processors of the device, the receiver to switch, while receiving via the receiver a third packet from the first transmitter, to receiving a fourth packet from the second transmitter.

14. The method according to claim 13, wherein
the second packet has a signal strength higher than a signal strength of the first packet, and
the fourth packet has a signal strength higher than a signal strength of the third packet.

15. The method according to claim 13, further comprising:
determining, by the controller of the device, that the second packet is to be transmitted at a first time from the second transmitter; and
responsive to the determination, sending, by the controller of the device before the first time, the first signal to the one or more processors.

16. The method according to claim 15, wherein
at least two of the controller, the receiver, the first transmitter, or the second transmitter communicate with one another using at least one of Universal Asynchronous Receiver-Transmitter (UART) or General-Purpose Input/Output (GPIO).

17. The method according to claim 16, further comprising:
determining, by the controller of the device, a duration for which the second packet is to be transmitted from the second transmitter; and
responsive to receiving the first signal, disallowing, by the one or more processors of the device for the duration, the receiver to switch to receiving the second packet from the second transmitter.

18. The method according to claim 13, further comprising:
determining, by the controller of the device, a session having a start time and an end time; and
responsive to determining the session, sending, by the controller of the device, the first signal at the start time to the one or more processors and sending the second signal at the end time to the one or more processors.

19. The method according to claim 18, further comprising:
determining, by the controller of the device, timing of traffic transmitted from the second transmitter; and
determining, by the controller of the device, the session according to the timing of the traffic transmitted from the second transmitter.

20. The method according to claim 18, wherein a duration of the session is greater than or equal to one second.
